(19) United States
(12) Patent Application Publication
(10) Pub. No.: US 2012/0162530 A1
(43) Pub. Date: Jun. 28, 2012

(54) Electronic Apparatus and Display Control Method

(76) Inventor: Koji Hachiya, Akishima-shi (JP)

(21) Appl. No.: 13/229,283

(22) Filed: Sep. 9, 2011

(30) Foreign Application Priority Data
Dec. 27, 2010 (JP) 2010-290996

(51) Int. Cl. H04N 5/268

(52) U.S. Cl. 348/705; 348/E05.057

(57) ABSTRACT

According to one embodiment, an electronic apparatus includes a storage module, a screen display module, a display mode switching module, and a display mode setting information adding module. The storage module stores pieces of display mode setting information indicating display modes. The screen display module displays a screen including items indicating the display modes and a first item for adding a new display mode. The display mode switching module switches a display mode based on first display mode setting information among the pieces of the display mode setting information when a second item of the items has been selected, the first display mode setting information corresponding to the second item. The display mode setting information adding module adds display mode setting information indicating a new display mode when the first item has been selected. The screen display module displays the screen further including an item indicating the new display mode.

### CROSS-REFERENCE TO RELATED APPLICATIONS

This application is based upon and claims the benefit of priority from prior Japanese Patent Application No. 2010-290996, filed Dec. 27, 2010, the entire contents of which are incorporated herein by reference.

### FIELD

Embodiments described herein relate generally to an electronic apparatus which switches a display device to which a video signal is output, and a display control method applied to the apparatus.

### BACKGROUND

In recent years, electronic apparatuses, such as a personal computer, to which a plurality of display devices can be connected, have been gaining in popularity. For example, in a notebook-type personal computer, video can be displayed by using, as well as a built-in liquid crystal display, an external display or a projector which is connected to the computer. In addition, the same video frame can be displayed at the same time on the built-in display and the external display (“clone display”) or different video frames can be displayed at the same time on the built-in display and the external display (“multi-display”). Such display modes are switched, for example, by the user selecting a to-be-used display device from a list indicative of display devices.

When the display device is switched, the user, in some cases, adjusts the resolution of the display device. For example, the user can set a proper resolution in accordance with the resolution which can be displayed by the display device or the content of the video that is displayed. However, it is time-consuming for the user to perform an operation of setting the resolution each time the display device is switched. Moreover, when a plurality of display devices are used in combination, as in the multi-display mode, the user is required to set resolutions of the display devices respectively.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic apparatus according to an embodiment.

FIG. 2 is an exemplary block diagram showing the system configuration of the electronic apparatus of the embodiment.

FIG. 3 shows an example of a screen for switching a display mode.

FIG. 4 shows another example of the screen for switching the display mode.

FIG. 5 is an exemplary block diagram illustrating the functional structure of a display control utility program which is executed by the electronic apparatus of the embodiment.

FIG. 6 shows an exemplary structure of display mode setting information which is used by the display control utility program executed by the electronic apparatus of the embodiment.

FIG. 7 shows an example of a display mode switching screen which is displayed by the electronic apparatus of the embodiment.

FIG. 8 shows an example in which a display mode is saved on the display mode switching screen which is displayed by the electronic apparatus of the embodiment.

FIG. 9 shows an example in which a display mode is added on the display mode switching screen which is displayed by the electronic apparatus of the embodiment.

FIG. 10 shows an example in which a display mode is selected on the display mode switching screen which is displayed by the electronic apparatus of the embodiment.

FIG. 11 shows another example in which a display mode is selected on the display mode switching screen which is displayed by the electronic apparatus of the embodiment.

FIG. 12 shows another example in which a display mode is added on the display mode switching screen which is displayed by the electronic apparatus of the embodiment.

FIG. 13 shows another example of the display mode switching screen which is displayed by the electronic apparatus of the embodiment.

FIG. 14 is an exemplary flowchart illustrating an example of the procedure of a display control process which is executed by the electronic apparatus of the embodiment.

### DETAILED DESCRIPTION

Various embodiments will be described hereinafter with reference to the accompanying drawings.

In general, according to one embodiment, an electronic apparatus includes a storage module, a screen display module, a display mode switching module, and a display mode setting information adding module. The storage module stores a plurality of pieces of display mode setting information indicative of a plurality of display modes. The screen display module displays a screen including a plurality of items indicative of the plurality of display modes and a first item for adding a new display mode. The display mode switching module switches a display mode based on first display mode setting information among the plurality of pieces of display mode setting information when a second item of the plurality of items has been selected, the first display mode setting information corresponding to the second item. The display mode setting information adding module adds display mode setting information to the storage module when the first item has been selected, the added display mode setting information indicating a new display mode which is currently used. The screen display module displays the screen which further includes an item indicative of the new display mode.

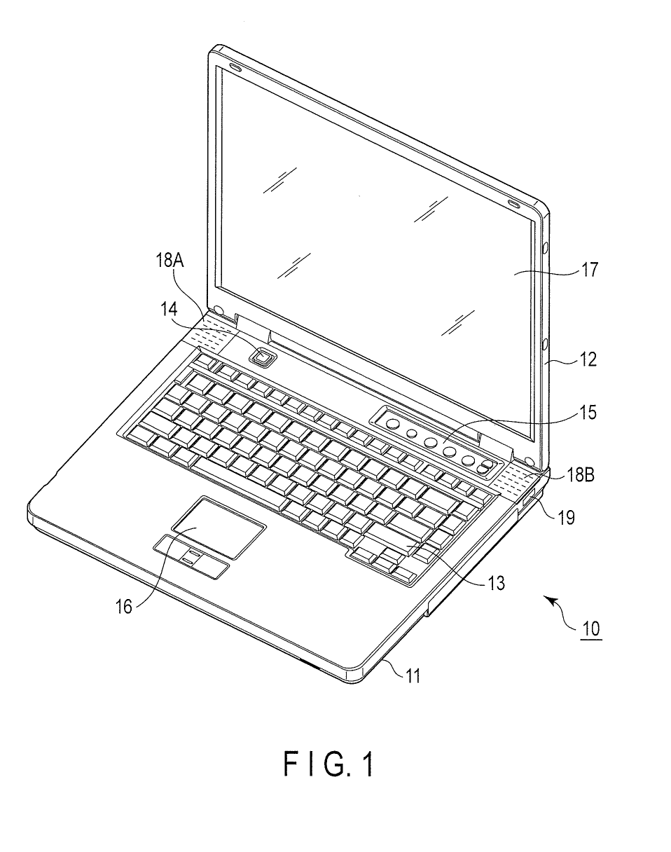

FIG. 1 is a view showing the external appearance of an electronic apparatus according to an embodiment. The electronic apparatus is realized, for example, as a notebook-type personal computer 10.

As shown in FIG. 1, the computer 10 includes a computer main body 11 and a display unit 12. A display device including a liquid crystal display (LCD) 17 is built in the display unit 12. The display unit 12 is attached to the computer main body 11 such that the display unit 12 is rotatable between an open position where the top surface of the computer main body 11 is exposed, and a closed position where the top surface of the computer main body 11 is covered.

The computer main body 11 has a thin box-shaped housing. A keyboard 13, a power button 14 for powering on/off the computer 10, an input operation panel 15, a touch pad 16, and speakers 18A and 18B are disposed on the top surface of the housing of the computer main body 11. Various operation buttons are provided on the input operation panel 15.

The right side surface of the computer main body 11 is provided with a universal serial bus (USB) connector 19 and an IEEE1394 connector 21. A USB cable or a USB device of, e.g. the USB 2.0 standard, are connected to the USB connector 19. A game pad controller, for instance, is connected to the USB connector 19. Further, the rear surface of the computer main body 11 is provided with, for example, a high-definition multimedia interface (HDMI) terminal which support the HDMI standard, a DVI terminal and an RGB terminal (not shown). The HDMI terminal and DVI terminal are used in order to output a digital video signal to an external display device (e.g. a display or a projector). Specifically, the HDMI terminal, DVI terminal and RGB terminal are used as video signal output ports for outputting video signals to the external display device.

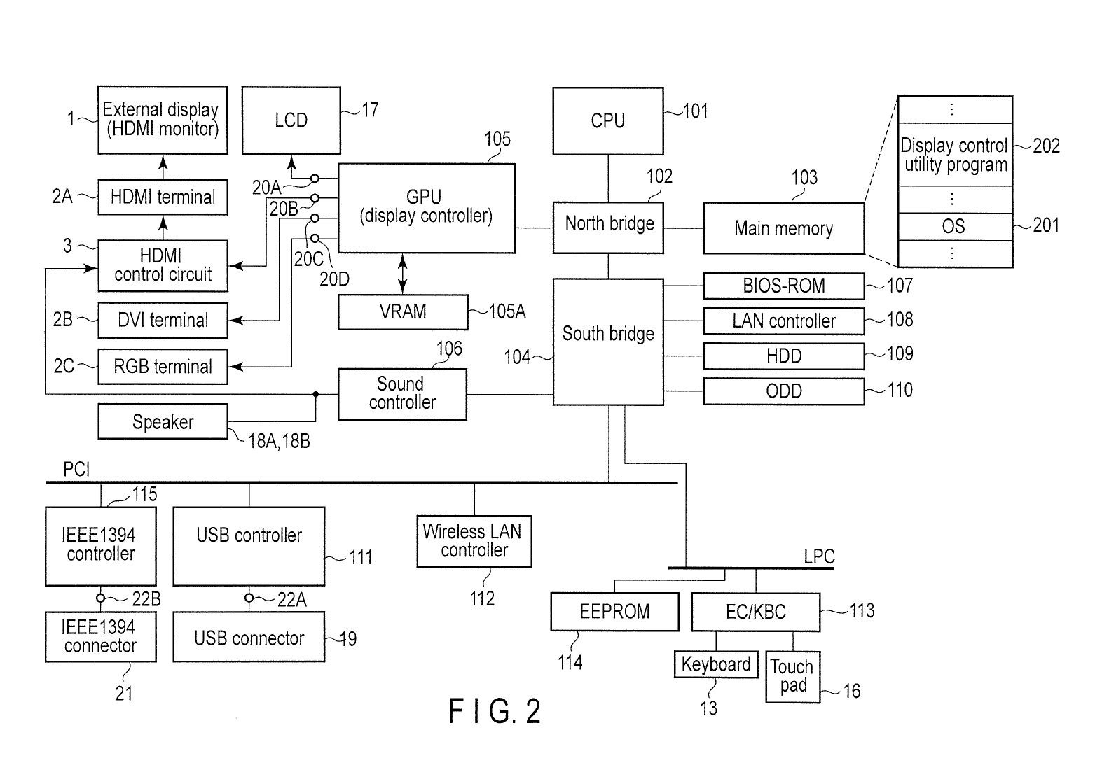

FIG. 2 shows the system configuration of the computer 10.

The computer 10, as shown in FIG. 2, includes a CPU 101, a north bridge 102, a main memory 103, a south bridge 104, a GPU 105, a video RAM (VRAM) 105A, a sound controller 106, a basic input/output system-read only memory (BIOS-ROM) 107, a local area network (LAN) controller 108, an HDD 109, an optical disc drive (ODD) 110, a USB controller 111, a wireless LAN controller 112, an embedded controller/keyboard controller (EC/KBC) 113, an electrically erasable programmable ROM (EEPROM) 114, and an IEEE1394 controller 115.

The CPU 101 is a processor for controlling the operation of respective components in the computer 10. The CPU 101 executes an operating system (OS) 201 and various application programs, such as a display control utility program 202, which are loaded from the HDD 109 into the main memory 103. The display control utility program 202 is software having a function of switching a display mode. The display control utility program 202 displays video in a display mode selected from a plurality of display modes, which are specified by one or more video signal output ports of a plurality of video signal output ports 20A to 20D and the resolutions of video signals which are output from the one or more video signal output ports.

Besides, the CPU 101 executes a BIOS that is stored in the BIOS-ROM 107. The BIOS is a program for hardware control.

The north bridge 102 is a bridge device which connects a local bus of the CPU 101 and the south bridge 104. The north bridge 102 includes a memory controller which access-controls the main memory 103. The north bridge 102 also has a function of executing communication with the GPU 105 via, e.g. a PCI EXPRESS serial bus.

The GPU 105 is a display controller which controls video signals which are output from the video signal output ports 20A to 20D. In addition, the GPU 105 controls the LCD 17 that is used as a display monitor of the computer 10. The GPU 105 sends a generated video signal (display signal) to the LCD 17 via the video signal output port 20A. In addition, the GPU 105 sends a digital video signal to an external display 1 via the video signal output port 20B, an HDMI control circuit 3 and an HDMI terminal 2A. The HDMI terminal 2A is the above-described external display connection terminal. The HDMI terminal 2A is capable of sending a non-compressed digital video signal and a digital audio signal to the external display device 1, such as a TV, via a single cable. The HDMI control circuit 3 is an interface for sending a digital video signal to the external display device 1, which is called “HDMI monitor”, via the HDMI terminal 2A.

The GPU 105 may send a digital video signal to the external display device via the video signal output port 20C and DVI terminal 2B. Further, the GPU 105 may send an analog video signal to the external display device via the video signal output port 20D and RGB terminal 2C. In the meantime, the video signal output ports 20B to 20D and the terminals 2A to 2C may be treated as video signal output ports.

The south bridge 104 controls devices on a Peripheral Component Interconnect (PCI) bus and devices on a Low Pin Count (LPC) bus. The south bridge 104 includes an Integrated Drive Electronics (IDE) controller for controlling the HDD 109 and ODD 110. The south bridge 104 also has a function of executing communication with the sound controller 106.

The sound controller 106 is a sound source device and outputs audio data, which is a playback target, to the speakers 18A and 18B or the HDMI control circuit 3.

The LAN controller 108 is a wired communication device which executes wired communication of, e.g. the IEEE 802.3 standard. On the other hand, the wireless LAN controller 112 is a wireless communication device which executes wireless communication of, e.g. the IEEE 802.11g standard. The USB controller 113 communicates with an external device which supports, e.g. the USB 2.0 standard, the external device being connected via the USB connector 19 and signal input/output port 22A. For example, the USB controller 113 executes communication at a time of receiving a signal which is output by an operation using a game pad controller which is an external device.

The IEEE1394 controller 115 communicates with an external device, which supports the IEEE1394 standard, via an IEEE1394 connector 21 and signal input/output port 22B. A video device such as a video camera is connected to the IEEE1394 connector 21.

The EC/KBC 113 is a one-chip microcomputer in which an embedded controller for power management and a keyboard controller for controlling the keyboard 13 and touch pad 16 are integrated. The EC/KBC 113 has a function of powering on/off the computer 10 in accordance with the user's operation of the power button 14.

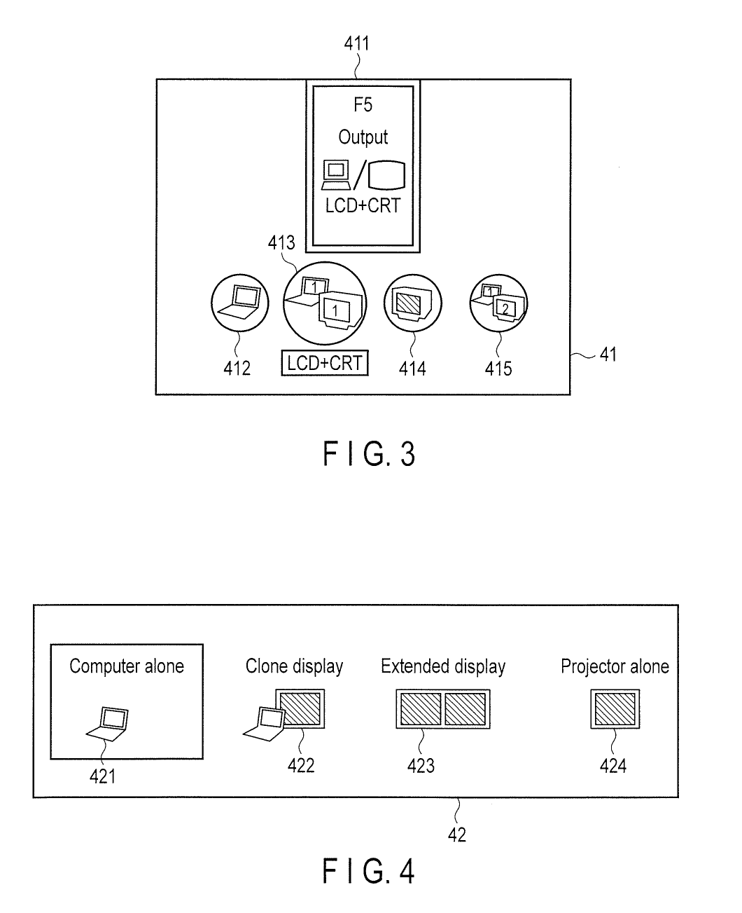

In the computer 10, the video display mode can be switched by using a switching screen 41 shown in FIG. 3 or a switching screen 42 shown in FIG. 4. The switching screen 41 includes items 412 to 415. The item 412 indicates that video is displayed on only the built-in display (LCD) 17 of the main body of the computer 10. The item 413 indicates that the same video is displayed on the built-in display (LCD) 17 and an external display (CRT) (this mode is also called “clone display”). The item 414 indicates that video is displayed on only the external display. The item 415 indicates that different videos are displayed on the built-in display 17 and the external display (this mode is also called “multi-display” or “extended display”). In addition, a display area 411 displays information representing the item which is currently selected (focused). In the switching screen 41, for example, in accordance with a key input by the user (e.g. an input of “Fn” key and “F5” key of the keyboard 13), the items 412 to 415 are successively displayed in a focused state. When one of the items 412 to 415 has been selected, video is displayed in a display mode corresponding to the selected item.

On the other hand, the switching screen 42 includes items 421 to 424. The item 421 indicates that video is displayed on only the built-in display 17 of the computer 10. The item 422 indicates that the same video is displayed on the built-in display 17 and an external display (this mode is also called “clone display”). The item 423 indicates that different videos are displayed on the built-in display 17 and the external display (“extended display”). The item 424 indicates that video is displayed on only a projector. Similarly in the switching screen 42, when one of the items 421 to 424 has been selected, video is displayed in a display mode corresponding to the selected item.

However, in the switching of the display mode using the switching screen 41, 42, it is possible to merely select one of a plurality of predetermined display modes (e.g. display modes determined by a vendor). Thus, when the user uses a display mode other than the predetermined display modes, the user has to perform a setting operation for using this display mode by using, for example, a tool which is provided by the OS 201. In addition, in the method using the switching screen 41, 42, only the display mode is switched, and the resolution, for instance, of the video signal that is output to the display device cannot be varied. Specifically, after changing the display mode with use of the switching screen 41, 42, the user has to set, for example, the resolution of the video signal that is output to the display device by using, for example, a tool which is provided by the OS 201. Such an operation as described above is very time-consuming for the user.

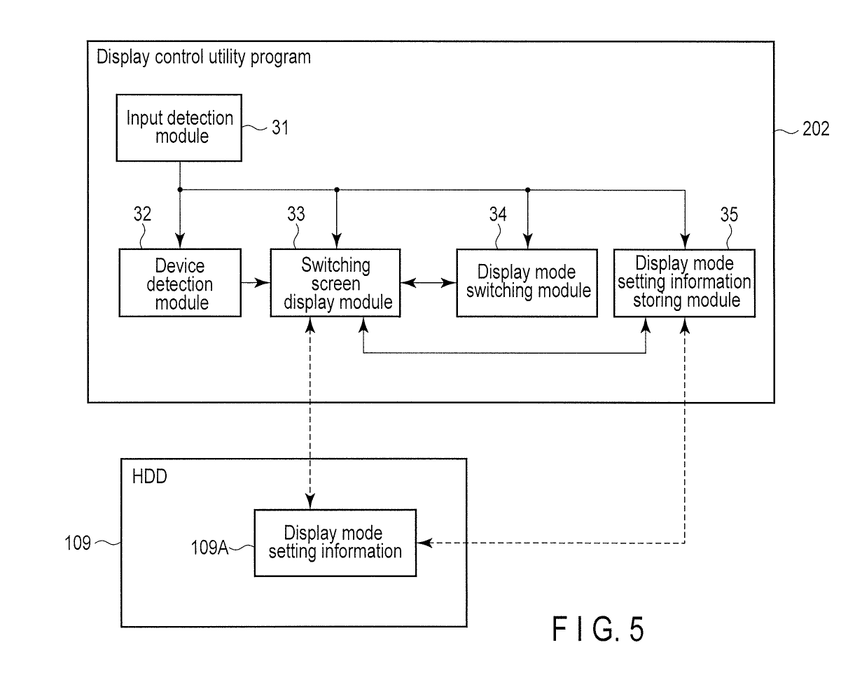

FIG. 5 illustrates a functional structure of the display control utility program 202 which operates on the computer 10 of the embodiment. The display control utility program 202 has a function (also referred to as “display mode switching function”) of switching to a designated display mode among a plurality of display modes stored in a storage device (e.g. HDD 109). Each of the plural display modes is specified by at least one video signal output port of the video signal output ports 20A to 20D and the resolution of a video signal which is output from the at least one video signal output port. In addition, the display control utility program 202 has a function (also referred to as “display mode saving function”) of adding a new display mode. The new display mode is, for example, a display mode which is set by the user by using a tool that is provided by the OS 201, etc. By the display mode saving function, the display control utility program 202 can easily save a new display mode (e.g. a display mode which is frequently used by the user). Besides, by the display mode switching function, the display control utility program 202 can easily switch to this newly stored display mode.

The display control utility program 202 includes an input detection module 31, a device detection module 32, a switching screen display module 33, a display mode switching module 34, and a display mode setting information storing module 35.

The input detection module 31 detects an input which requests display of a display mode switching screen. The input detection module 31 detects, for example, the input of a predetermined combination of keys (e.g. a hot key operation in which the “Fn” key and the “F5” key of the keyboard 13 are pressed at the same time) as a request for displaying the display mode switching screen. The input detection module 31 notifies the device detection module 32 and switching screen display module 33 that the input requesting the display of the display mode switching screen has been detected.

The device detection module 32 detects the connection state of a device in response to the notification by the input detection module 31. For example, the device detection module 32 detects whether a display device (e.g. a display, a projector) is connected via one of the video signal output ports 20A to 20D (e.g. HDMI terminal, DisplayPort terminal, DVI terminal, RGB terminal). In addition, the device detection module 32 detects whether an input device (e.g. a game pad controller) is connected to one of signal input/output ports 22A and 22B (e.g. IEEE1394 connector, USB connector). To be more specific, the device detection module 32 inquires whether the display device or input device is available, for example, via the OS 201 or a driver API. Besides, the device detection module 32 detects which of the interfaces (video signal output ports 20A to 20D and signal input/output ports 22A and 22B) is used for the connection of the display device or input device. The interfaces are, for instance, HDMI, DisplayPort, DVI, RGB, IEEE1394, USB, etc.

The device detection module 32 outputs device connection information, which is indicative of the connection state of the device, to the switching screen display module 33. The device connection information includes, for example, information indicative of one or more display devices and one or more video signal output ports to which the one or more display devices are connected. The one or more display devices (one or more display devices which are capable of displaying video) are connected to the one or more video signal output ports provided on the computer 10. Furthermore, the device connection information includes, for example, information indicative of the input device (available input device) which is connected to the computer 10, and information indicative of the signal input (input/output) port to which the input device is connected.

In response to the notification by the input detection module 31, the switching screen display module 33 reads display mode setting information 109A from the HDD 109. Then, the switching screen display module 33 generates a display mode switching screen for switching the display mode, based on the read display mode setting information 109A and the device connection information output by the device detection module 32. The display mode switching screen includes, for example, an item indicative of a display mode among a plurality of display modes indicated in the display mode setting information 109A, and an item for adding a new display mode. The display mode of the item in the display mode switching screen is a switchable display mode based on the connection state of the display device and input device.

Specifically, in accordance with an available device (e.g. display device, input device) which is indicated in the device connection information, the switching screen display module 33 detects an available display mode among the plural display modes indicated in the display mode setting information 109A. In other words, when all of display devices or input devices, which are used in a certain display mode, are available, the switching screen display module 33 detects this display mode as the available display mode. On the other hand, when any one of the display devices or input devices, which are used in a certain display mode, is not available, the switching screen display module 33 detects this display mode as an unavailable display mode. Based on the detection result, the switching screen display module 33 generates the display mode switching screen including items indicative of the respective available display modes and an item for adding a new display mode. Accordingly, for example, when the external display 1 is not connected via the HDMI terminal 2A, the display mode switching screen does not include an item indicative of the display mode using the external display 1 which is connected via the HDMI terminal 2A. For example, when a display device is connected via the DVI terminal 2B, the display mode switching screen includes an item indicative of the display mode using the display device which is connected via the DVI terminal 2B. In the meantime, the display mode switching screen may include items for editing and deleting the plural display modes indicated in the display mode setting information 109A. The switching screen display module 33 displays the generated display mode switching screen.

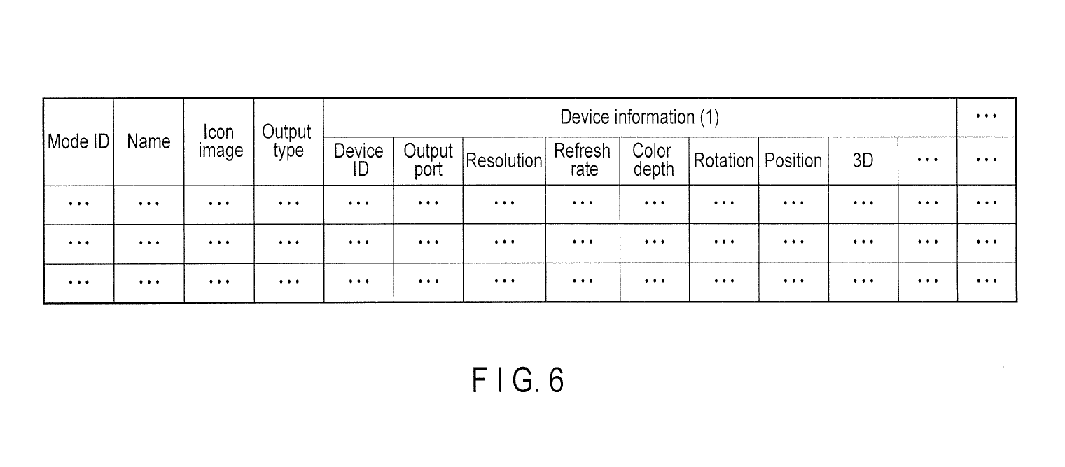

FIG. 6 shows a structure example of the display mode setting information 109A. The display mode setting information 109A is stored in, for example, the HDD 109. The display mode setting information 109A includes a plurality of entries corresponding to a plurality of display modes. Each of the entries includes, for example a display mode identifier (display mode ID), a name, an icon image, an output type, and device information. In the entry corresponding to a certain display mode, “Display mode ID” is indicative of identification information which is given to the display mode. “Name” is indicative of the name which is given to the display mode. This name is given by, for example, the user. “Icon image” is indicative of an icon image which is associated with the display mode. The “Icon image” is indicative of, for example, a file name (file path) of an image which is used as an icon. “Output type” is indicative of a mode for outputting a video signal to the display device in the display mode. Specifically, the “Output type” is indicative of, for example, any one of single display, clone display and multi-display. The single display is a type for outputting a video signal to a single display device. The clone display is a type for outputting the same video signal to two or more display devices. The multi-display is a type for outputting different video signals to two or more display devices.

“Device information” is information of a display device which is used in the display mode. When a plurality of display devices are used in a certain display mode, the entry corresponding to this display mode includes a plurality of pieces of “Device information” corresponding to the plural display devices. The “Device information” includes, for example, a device ID, an interface, a resolution, a refresh rate (display frequency), a color depth, a rotation, a position, and three dimension (3D). In the “Device information” corresponding to a certain display device, “Device ID” is indicative of identification information which is unique to the display device. “Output port” is indicative of a video signal output port in the computer 10, to which the display device is connected. Specifically, the “Output port” is indicative of a video signal output port such as HDMI, DisplayPort, DVI, or RGB. Besides, the “Output port” may indicate a signal input/output port such as IEEE1394 or USB. Furthermore, the “Output port” may indicate a video signal output port for outputting a video signal to the built-in display 17. “Resolution” is indicative of the resolution of a video signal which is output to the display device. “Refresh rate” is indicative of the rate (e.g. 60 Hz, 120 Hz) at which the display of video in the display device is updated. “Color depth” is indicative of the color depth which is used in the display device. “Rotation” is indicative of an angle (e.g. 90 degrees, 180 degrees) at which the display device is rotated. “Position” is indicative of the position of the display device. The “Position” is used, for example, in order to represent an arrangement of a plurality of display devices in the multi-display. “3D” is indicative of enabling or disabling of 3D video display. In the meantime, the device information may be information of the input device which is used in the display mode.

The input detection module 31 shown in FIG. 5 also detects an input using the display mode switching screen. Specifically, the input detection module 31 detects an input which selects an item in the display mode switching screen. When the user has selected any one of the items indicative of the plural display modes in the display mode switching screen, the input detection module 31 notifies the display mode switching module 34 that an input requesting the switching of the display mode has been detected. When the user has selected an item indicative of the change of the display mode in the display mode switching screen, the input detection module 31 notifies the display mode setting information storing module 35 that an input requesting the change of the display mode has been detected. In addition, when the user has selected an item indicative of the storing (saving) of a new display mode in the display mode switching screen, the input detection module 31 notifies the display mode setting information storing module 35 that an input requesting the storing of the new display mode has been detected.

The display mode switching screen is displayed, for example, in response to a hot key operation in which the “Fn” key and “F5” key are pressed at the same time, as described above. At this time, for example, if the user repeatedly presses the “F5” key while keeping on pressing the “Fn” key, the plural items in the display mode switching screen are successively set in the focused state. For example, when a plurality of items are horizontally arranged in the display mode switching screen, these items are successively set in the focused state from the leftmost one to the rightmost one, each time the “F5” key is pressed while the “Fn” key is being pressed. When the user finishes the pressing of the “Fn” key and “F5” key, the input detection module 31 detects the item, which is in the focused state immediately before, as the item that is selected by the user.

When one of the plural items in the display mode switching screen is being focused, the switching screen display module 33 displays this item, for example, by surrounding it in a frame border, so that the user can easily distinguish this item from the other items. In addition, the switching screen display module 33 may display information relating to this item, for example, on a pop-up screen. For example, the switching screen display module 33 displays information, which indicates the display mode corresponding to this item, on the pop-up screen when a focused item is one of the items indicative of the plural display modes. The pop-up screen displays, for example, by using text or an icon image, the information indicative of one or more video signal output ports and the resolution of the video signal that is output from the one or more video signal output ports, which are specified for the display mode.

In response to the notification by the input detection module 31 about the request for switching the display mode, the display mode switching module 34 switches to the designated display mode. The display mode switching module 34 outputs the video signal of the specified resolution from one or more specified video signal output ports, based on the entry of the display mode setting information 109A which corresponds to the designated display mode. After the display mode has been switched by the display mode switching module 34, the switching screen display module 33 terminates the display of the display mode switching screen.

As has been described above, the display mode switching module 34 can easily switch to the selected display mode among the plural display modes stored as the display mode setting information 109A. In addition, the user can make a further change to the switched display mode, for example, by using a tool provided by the OS 201. For example, the user can change the resolution of the video signal which is output from one video signal output port, among one or more video signal output ports from which video signals are being output. In addition, the user can make such a change that a video signal is output from a video signal output port, in addition to the one or more video signal output ports from which video signals are being output. Moreover, the user can select one or more video signal output ports from the plural video signal output ports 20A to 20D provided in the computer 10, and can set the resolution of the video signal which is output from the selected video signal output port.

In this manner, when video is displayed (i.e. a video signal is output) in a display mode that is different from the display modes which are stored, the display control utility program 202 (display mode setting information storing module 35) can further store display mode setting information indicative of the new display mode.

Specifically, the input detection module 31 detects an input with use of the display mode switching screen, the input requesting the storing of a new display mode. For example, when the user has selected an item indicative of storing of a new display mode in the display mode switching screen, the input detection module 31 notifies the display mode setting information storing module 35 that an input requesting the storing of the new display mode has been detected.

In response to the notification by the input detection module 31, the display mode setting information storing module 35 displays a display mode registration screen for inputting a name, etc., which are associated with the new display mode. Using the display mode registration screen that is displayed, the user inputs the name, etc., which are associated with the new display mode. The display mode setting information storing module 35 stores in the HDD 109 the information indicative of the currently used display mode, as well as the information which has been input by using the display mode registration screen. Specifically, the display mode setting information storing module 35 adds to the display mode setting information 109A the entry including the information indicative of the currently used display mode. The added entry includes the information indicative of one or more video signal output ports corresponding to the currently used display mode, and the resolution of each of video signals which are output from the one or more video signal output ports. The added entry also includes information indicative of, e.g. the name, icon image, and output type, etc. In the meantime, the display mode setting information storing module 35 may determine, from among a plurality of images stored in, e.g. the HDD 109, an image file which is used for an icon image, in accordance with the video signal output port, output type, etc. In short, the display mode setting information storing module 35 selects an icon image which is suited to the display mode.

When an input requesting the display of a display mode switching screen has been detected by the input detection module 31 after the display mode setting information indicative of the new display mode was stored by the display mode setting information storing module 35, the switching screen display module 33 generates and displays a display mode switching screen. The display mode switching screen further includes an item corresponding to the new display mode, based on a plurality of pieces of display mode setting information (also referred to as “a plurality of pieces of first display mode setting information”) which have already been stored in the HDD 109 and display mode setting information (also referred to as “second display mode setting information”) which has newly been stored by the display mode setting information storing module 35. Using this display mode switching screen, the user can easily switches to the newly saved display mode.

The display mode setting information storing module 35 displays a setting screen for editing or deleting the display mode setting information which is associated with, for example, one of the plural display modes which are stored when the item for changing the stored display mode has been selected by using the display mode switching screen. Specifically, by selecting the item for changing the saved display mode, the user can edit or delete the display mode setting information 109A corresponding to the designated display mode with use of the setting screen. For example, by using the setting screen, the user can change the order of items (icons) included in the display mode switching screen, the name of the display mode, the content of the display mode, etc. Besides, the user can delete, for example, one of the plural display modes.

By the above-described structure, the display control utility program 202 can easily switch the display mode. In response to the request for switching the display mode, the switching screen display module 33 displays the display mode switching screen including the plural items indicative of the plural saved display modes and the item for adding a new display mode, by using the plural pieces of first display mode setting information 109A. The user selects the item corresponding to the display mode, which is to be used, from among the plural items indicative of the plural saved display modes, and thereby the display mode switching module 34 effects switching to the display mode corresponding to the selected item. In addition, the user selects the item for adding a new display mode, and thereby the display mode setting information storing module 35 stores the second display mode setting information indicative of the present display mode in the HDD 109. When the display mode switching screen is displayed at the next time, the switching screen display module 33 displays the display mode switching screen which further includes the item indicative of the new display mode, based on the plural pieces of first display mode setting information and the second display mode setting information. By the above-described operations, it is possible to save, for example, the display mode which is frequently used by the user, and to easily return to this display mode.

The display mode may be further specified by a specific device. In this case, when this specific device is connected to the video signal output port, 20A to 20D, or the signal input/output port 22A, 22B, of the computer 10, the switching screen display module 33 displays the display mode switching screen including the item indicative of the display mode which uses this specific device. In addition, when this specific device is not connected to the video signal output port, 20A to 20D, or the signal input/output port 22A, 22B, of the computer 10, the switching screen display module 33 displays the display mode switching screen which does not include the item indicative of the display mode which uses this specific device. The device is specified by, for example, identification information (e.g. EEID) which is unique to the device. It is thus possible to specify the display mode using a TV receiver having identification information “A001”, for example, among display devices which are connected via the HDMI terminal 2A.

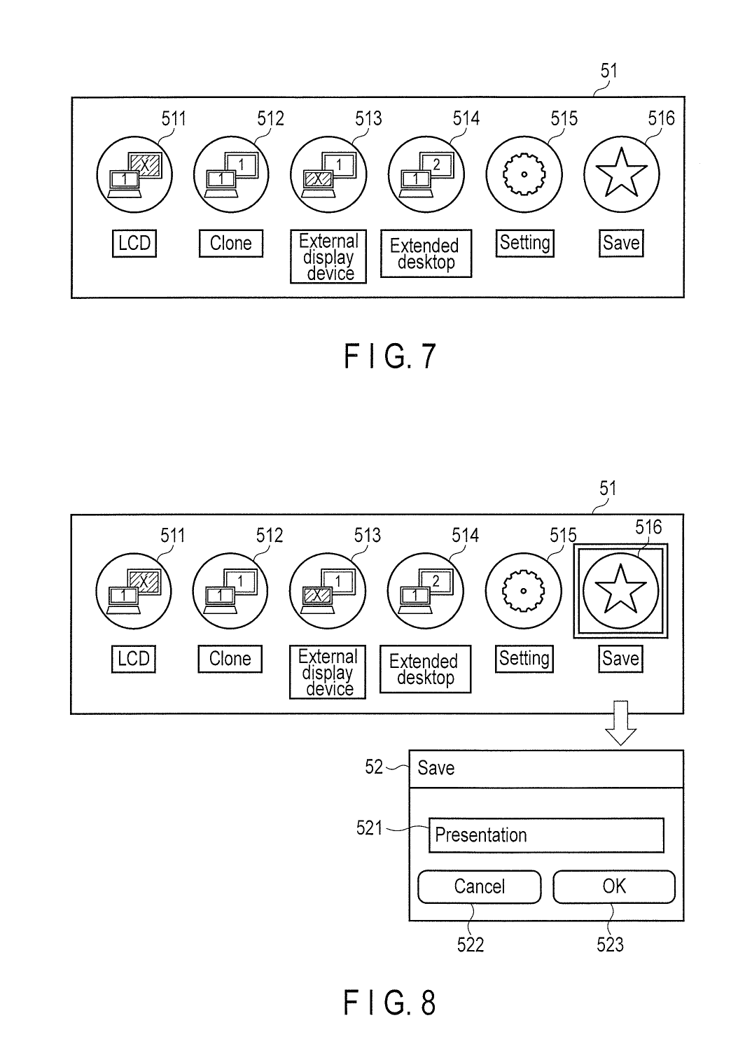

FIGS. 7 to 13 show examples of the display mode switching screen which is displayed by the display control utility program 202 (switching screen display module 33).

FIG. 7 shows an example of a display mode switching screen 51 which is generated based on the display mode setting information 109A. The display mode switching screen 51 includes switching icons 511 to 514, a setting icon 515 and a save icon 516. The switching icons 511 to 514 are icons for switching to a plurality of display modes which are indicated in the display mode setting information 109A. The setting icon 515 is an icon for changing an already saved display mode. The save icon 516 is an icon for adding a new display mode.

The switching icon 511 indicates that video is displayed on the built-in display (LCD) 17 alone. The switching icon 512 indicates that the same video is displayed on the built-in display 17 and external display 1 (“clone”). The switching icon 513 indicates that video is displayed on the external display 1 alone. The switching icon 514 indicates that different videos are displayed on the built-in display 17 and external display 1 (“extended desktop”). The setting icon 515 indicates that a plurality of saved display modes (i.e. entries of the display mode setting information 109A) are edited or deleted. The save icon 516 indicates that a new display mode is saved.

When any one of the switching icons 511 to 514 has been selected, the display mode switching module 34 switches to the display mode corresponding to the selected switching icon. When the setting icon 515 has been selected, the display mode setting information storing module 35 edits or deletes the display mode setting information 109A corresponding to a designated display mode, for example, by using an input screen for editing or deleting a plurality of saved display modes. When the save icon 516 has been selected, the display mode setting information storing module 35 adds an entry of the display mode setting information indicative of the currently used display mode to the display mode setting information 109A which is stored in the HDD 109.

FIG. 8 shows an example of a display mode registration screen 52 which is displayed when the save icon 516 has been selected. When the save icon 516 has been selected, the switching screen display module 33 displays the display mode registration screen 52. The user inputs a name (e.g. “Presentation”), which is to be associated with a newly saved display mode, in a name input area 521 in the display mode registration screen 52. In response to the pressing of an OK button 523 by the user, the display mode setting information storing module 35 adds to the display mode setting information 109A an entry of display mode setting information indicative of the input name and the currently used display mode. In this case, it is assumed that a display mode, in which the output type is multi-display, a video signal with a resolution of 1280×800 is output to the built-in display 17 and a video signal with a resolution of 1024×768 is output to the external display device which is connected via the RGB terminal 2C, has been saved as the new display mode “Presentation”.

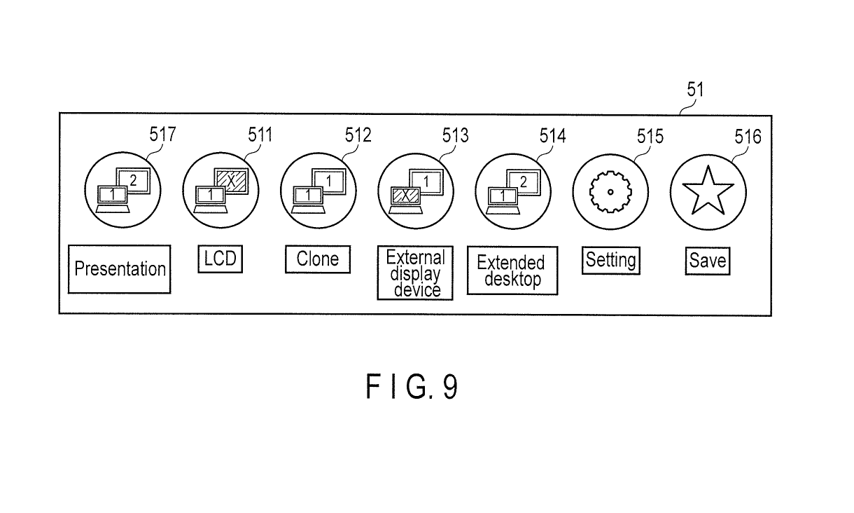

When the switching of the display mode has been requested after the new display mode “Presentation” was saved, the switching screen display module 33 displays, a shown in FIG. 9, the display mode switching screen 51 which further includes a switching icon 517 corresponding to the new display mode. In the display mode switching screen 51 shown in FIG. 9, the switching icon 517 indicative of the new display mode “Presentation” is added at the left end. The user can recognize, from the icon image of the switching icon 517, that the output type in the display mode of “Presentation” is multi-display by two display devices.

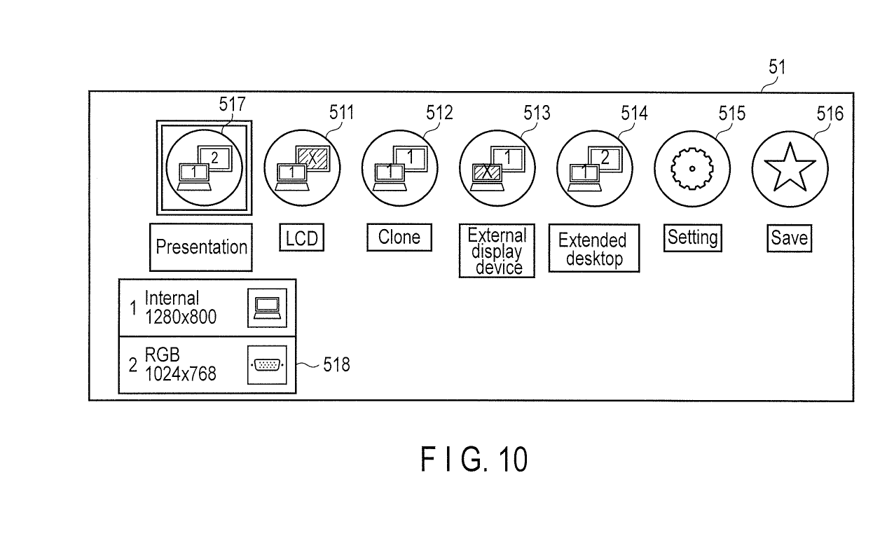

When the switching icon 517 has been focused, the switching screen display module 33 displays, as shown in FIG. 10, a pop-up window 518 indicative of the information of the display mode corresponding to the switching icon 517. By the pop-up window 518, the user can confirm that in the display mode of “Presentation”, a video signal with the resolution of 1280×800 pixels is output from the video signal output port 20A to which the built-in display 17 is connected, and a video signal with the resolution of 1024×768 pixels is output from the video signal output port 20D (RGB terminal 2C) to which the external display device is connected.

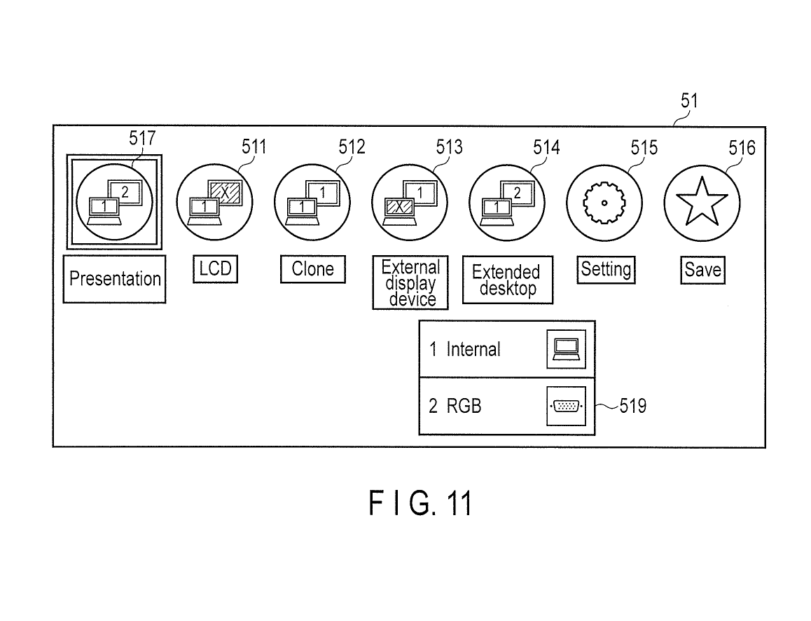

In the meantime, like a pop-pop window 519 shown in FIG. 11, only information indicative of the combination of video signal output ports may be displayed. The pop-up window 519 is used, for example, when one or more video signal output ports alone are specified in the display mode, and the resolutions of video signals, which are output from the video signal output ports, are not specified.

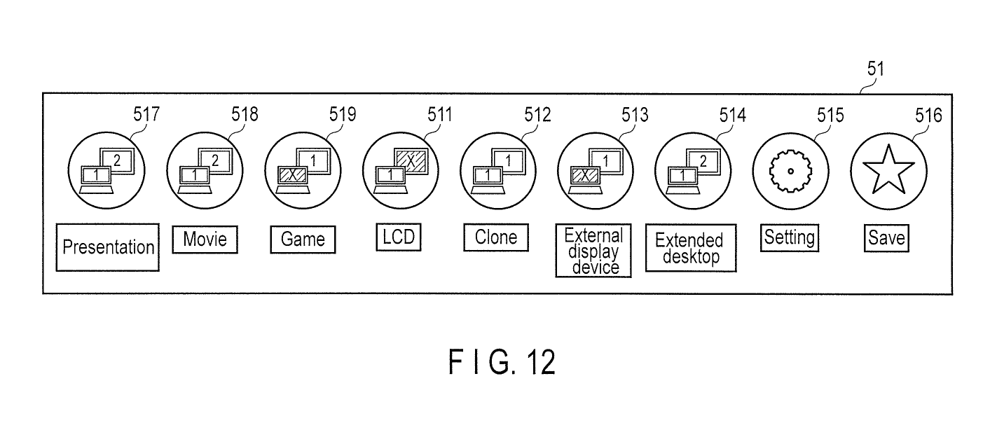

Furthermore, the display control utility program 202 can add a plurality of new display modes. In a display mode switching screen 51 shown in FIG. 12, a switching icon 518 corresponding to a display mode of “Movie” and a switching icon 519 corresponding to a display mode of “Game” are further added, in addition to the switching icon 517 corresponding to the display mode of “Presentation”. In other words, an entry indicative of the display mode associated with a name “Movie” and an entry indicative of the display mode associated with a name “Game” have been newly added to the display mode setting information 109A by the display mode setting information storing module 35. The display mode of “Movie” is, for example, a display mode in which the resolution (aspect ratio) of the video signal is optimized in order for the user to view a movie. Besides, the display mode of “Game” is, for example, a display mode which is associated with a game pad controller or the like, in order for the user to play a TV game.

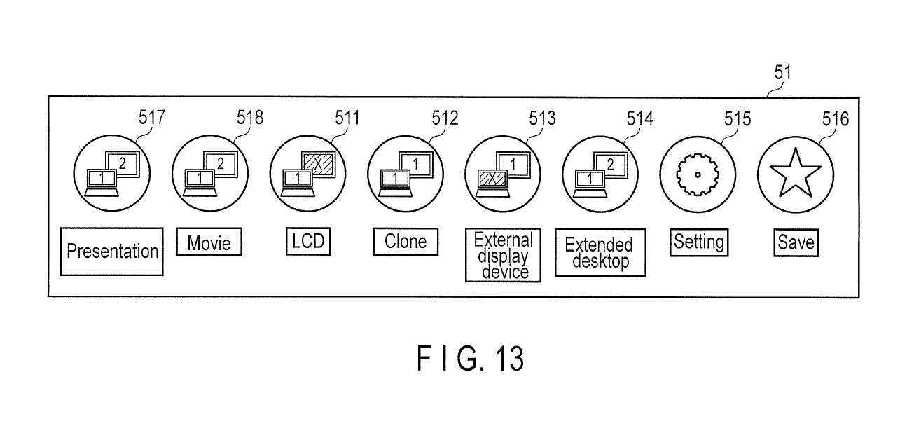

The switching screen display module 33, as described above, displays the display mode switching screen 51, based on the display mode setting information 109A and the device connection information. In accordance with an available device (e.g. display device, input device) which is indicated in the device connection information, the switching screen display module 33 detects an available display mode among the plural display modes indicated in the display mode setting information 109A. In other words, when all of display devices or input devices which are used in a certain display mode are available, the switching screen display module 33 detects this display mode as the available display mode. Thus, for example, when a game pad controller, which is used in the display mode of “Game”, is not connected to the computer 10, the switching screen display module 33 detects the display mode of “Game” as an unavailable display mode. Then, as shown in FIG. 13, the switching screen display module 33 generates a display mode switching screen 51 which does not include the switching icon 519 corresponding to the display mode of “Game”.

Similarly, for example, when an external display device, which is used in the display mode of “Presentation”, is in the power-off state, the switching screen display module 33 detects the display mode of “Presentation” as an unavailable display mode. Then, the switching screen display module 33 generates a display mode switching screen 51 which does not include the switching icon 517 corresponding to the display mode of “Presentation”.

By using the display mode switching screen 51 which includes only icons of available display modes based on the device connection information, among a plurality of display modes based on the display mode setting information 109A, the user can recognize actually selectable display modes. In addition, it is possible to prevent degradation in operability at the time of selecting the display mode, which would occur if the display mode switching screen includes an icon indicative of an unavailable display mode.

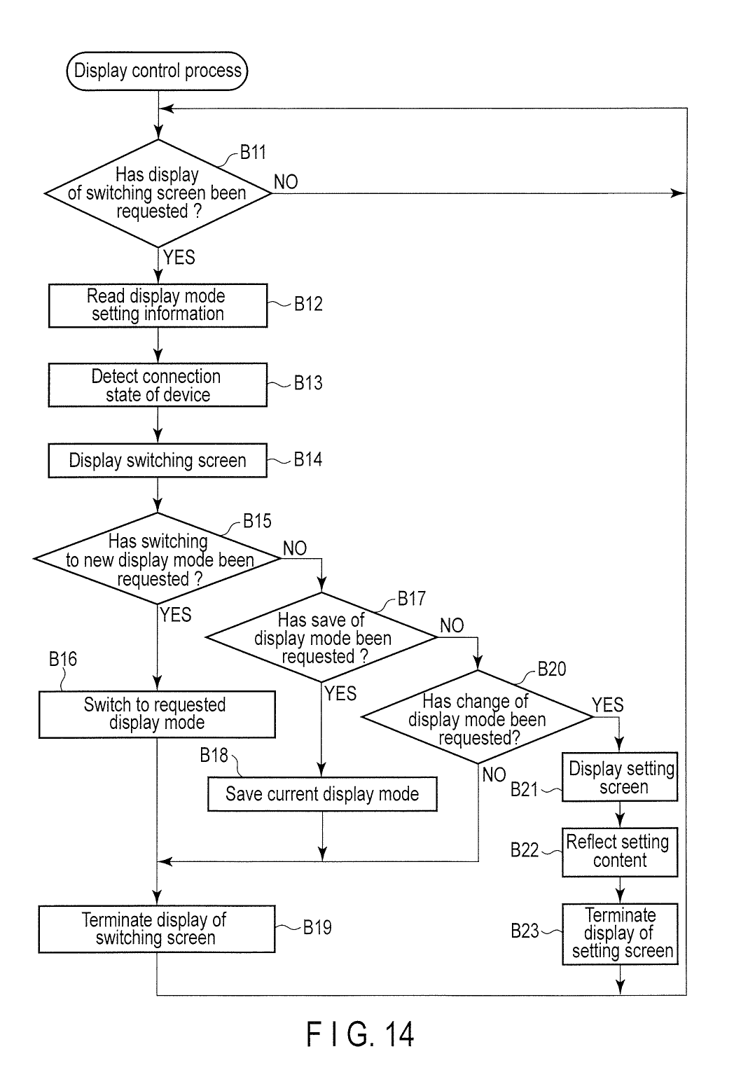

Next, referring to a flowchart of FIG. 14, a description is given of an example of the procedure of a display control process which is executed by the electronic apparatus 10.

To start with, the input detection module 31 determines whether an input which requests display of a display mode switching screen has been detected (block B11). For example, when a predetermined combination of keys has been input (for example, when the “Fn” key and “F5” key of the keyboard 13 have been pressed at the same time), the input detection module 31 determines that an input which requests display of a display mode switching screen has been detected.

When an input which requests display of a display mode switching screen has not been detected (NO in block B11), the input detection module 31 determines once again whether an input which requests display of a display mode switching screen has been detected by returning to block B11.

When an input which requests display of a display mode switching screen has been detected (YES in block B11), the switching screen display module 33 reads display mode setting information 109A from the HDD 109 (block B12). Then, the device detection module 32 detects a connection state of a device (block B13). Specifically, the device detection module 32 detects whether a display device (e.g. a display, a projector) or an input device (e.g. a game pad controller) is connected to the input/output port (e.g. a video signal output port, a signal input port) which is provided in the computer 10. The device detection module 32 detects which of input/output ports (interfaces) is connected to the display device or the input device. The interface is, for instance, HDMI, DisplayPort, DVI, RGB, IEEE1394, USB, etc.

The switching screen display module 33 displays a display mode switching screen for switching the display mode, based on the read display mode setting information 109A and the device connection of the device which has been detected by the device detection module 32 (block B14). Specifically, the switching screen display module 33 detects a switchable display mode based on the connection state of the display device, among a plurality of display modes indicated in the display mode setting information 109A. The switching screen display module 33 generates a display mode switching screen which includes items indicative of the detected display modes and an item for adding a new display mode. Then, the switching screen display module 33 displays the generated display mode switching screen.

Subsequently, the input detection module 31 determines whether switching of the display mode has been requested by using the display mode switching screen (block B15). For example, when the user has selected any one of the items indicative of the plural display modes in the display mode switching screen, the input detection module 31 determines that the switching to the display mode corresponding to the selected item has been requested. In the meantime, when one of the items indicative of the plural display modes is being focused, the switching screen display module 33 may display information indicative of the display mode corresponding to the focused item, for example, on a pop-up screen.

When the switching of the display mode has been requested (YES in block B15), the display mode switching module 34 switches to the requested display mode (block B16). Based on the display mode setting information 109A corresponding to the selected display mode, the display mode switching module 34 outputs video signals of specified resolutions from one or more specified video signal output ports. Then, the switching screen display module 33 terminates the display of the display mode switching screen (block B19).

On the other hand, when the switching of the display mode has not been requested (NO in block B15), the input detection module 31 determines whether save of a new display mode has been requested (block B17). For example, when the user has selected the item for adding a new display mode in the display mode switching screen, the input detection module 31 determines that save of a new display mode has been requested.

When the save of a new display mode has been requested (YES in block B17), the display mode setting information storing module 35 adds to the HDD 109 the display mode setting information indicative of the currently used display mode (block B18). Specifically, the display mode setting information storing module 35 adds an entry including information indicative of the currently used display mode to the display mode setting information 109A which is stored in the HDD 109. After the current display mode is saved, the switching screen display module 33 terminates the display of the display mode switching screen (block B19).

In addition, when the save of a new display mode has not been requested (NO in block B17), the input detection module 31 determines whether a change of the setting of the display mode has been requested (block B20). For example, when the user has selected an item for changing the setting of the display mode in the display mode switching screen, the input detection module 31 determines that a change of the setting of the display mode has been requested. When a change of the setting of the display mode has been requested (YES in block B20), the switching screen display module 33 displays a setting screen (block B21). Using the setting screen, the user can designate, for example, a change of the order of items (icons) in the display mode switching screen, the name of the display mode, and the content of the display mode (e.g. the video signal output port, resolution, refresh rate, color depth, etc.). In addition, the user can designate deletion of the display mode by using the setting screen. On the setting screen, it is possible to perform an operation of editing or deleting not only the currently used display mode, but also all the display modes which have been already saved.

Then, the display mode setting information storing module 35 reflects the user's instruction (setting content) on the display mode setting information 109A (block B22). Specifically, for example, in accordance with the user's instruction, the display mode setting information storing module 35 updates the entry of the display mode setting information 109A corresponding to the display mode, the change of which has been requested. In addition, for example, in accordance with the user's instruction, the display mode setting information storing module 35 deletes the entry of the display mode setting information 109A corresponding to the display mode, the deletion of which has been requested. When the content of the currently used display mode has been changed, the display mode switching module 34 outputs a video signal corresponding to the changed content, based on the updated entry of the display mode setting information 109A. The switching screen display module 33 terminates the display of the setting screen (block B23).

On the other hand, when the change of the setting of the display mode has not been requested (NO in block B20), that is, when the user has selected the item corresponding to the currently used display mode in the display mode switching screen and thus none of the switching, the save and the change of the display mode has been requested, the switching screen display module 33 terminates the display of the display mode switching screen (block B19). Then, the input detection module 31 determines once again whether an input which requests display of a display mode switching screen has been detected by returning to block B11. In the meantime, the switching screen display module 33 may terminate the display of the display mode switching screen, when a period, in which none of the items in the display mode switching screen is selected, has passed since the display of the display mode switching screen, and the period has reached a threshold period.

As has been described above, according to the present embodiment, the display mode can easily be switched. The switching screen display module 33 displays the display mode switching screen including the plural items indicative of the plural saved display modes and the item for adding a new display mode, by using the display mode setting information 109A and the device connection information. The user selects the item corresponding to the display mode, which is to be used, from among the items in the display mode switching screen, and thereby the display mode switching module 34 effects switching to the display mode corresponding to the selected item. In addition, the user selects the item for saving a new display mode in the display mode switching screen, and thereby the display mode setting information storing module 35 additionally stores the entry of the display mode setting information indicative of the present display mode in the display mode setting information 109A (HDD 109). When the display mode switching screen is displayed at the next time, the switching screen display module 33 displays the display mode switching screen which further includes the item corresponding to the new display mode, based on the display mode setting information stored by the display mode setting information storing module 35. By using this display mode switching screen, it is possible to save, for example, the display mode which is frequently used by the user, and to easily return to this display mode.

All the procedures of the display control process in this embodiment may be executed by software. Thus, the same advantageous effects as with the present embodiment can easily be obtained simply by installing a computer program, which executes the procedures of the display control process, into an ordinary computer through a computer-readable storage medium, and by executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a storage module configured to store a plurality of pieces of display mode setting information indicative of a plurality of display modes;
a screen display module configured to display a screen comprising a plurality of items indicative of the plurality of display modes and a first item for adding a new display mode;
a display mode switching module configured to switch the display mode based on first display mode setting information among the plurality of pieces of display mode setting information when a second item of the plurality of items has been selected, the first display mode setting information corresponding to the second item; and
a display mode setting information adding module configured to add display mode setting information to the storage module when the first item has been selected, the added display mode setting information indicating a new display mode which is currently used,
wherein the screen display module is configured to display the screen which further comprises an item indicative of the new display mode.

2. The electronic apparatus of claim 1, wherein the plurality of display modes and the new display mode are specified by one or more video signal output ports of a plurality of video signal output ports and by resolutions of video signals output from the one or more video signal output ports.

3. The electronic apparatus of claim 2, further comprising a connection detection module configured to detect a connection state of one or more display devices connected to the one or more video signal output ports,
wherein the screen display module is configured to detect a switchable display mode among the plurality of display modes and the new display mode based on the detected connection state, and to display a screen comprising an item indicative of the detected display mode and the first item.

4. The electronic apparatus of claim 3, wherein the plurality of display modes and the new display mode are further specified by identification information which is unique to each of the one or more display devices connected to the one or more video signal output ports,
the connection detection module is configured to further detect the identification information which is unique to each of the one or more display devices, and
the screen display module is configured to detect the switchable display mode among the plurality of display modes and the new display mode based on the detected connection state and the detected identification information, and to display a screen comprising an item indicative of the detected display mode and the first item.

5. The electronic apparatus of claim 3, wherein one of the plurality of display modes or the new display mode is further specified by one or more signal input ports of a plurality of signal input ports,
the connection detection module is configured to further detect a connection state of one or more input devices connected to the one or more signal input ports, and
the screen display module is configured to detect the switchable display mode among the plurality of display modes and the new display mode based on the detected connection state of the one or more display devices and the detected connection state of the one or more input devices, and to display the screen comprising the item indicative of the detected display mode and the first item.

6. The electronic apparatus of claim 2, wherein the plurality of display modes and the new display mode are specified by any one of single display, clone display and multi-display, the single display outputting a video signal from one video signal output port of the plurality of video signal output ports, the clone display outputting an identical video signal from two or more video signal output ports of the plurality of video signal output ports, the multi-display outputting different video signals from two or more video signal output ports of the plurality of video signal output ports.

7. The electronic apparatus of claim 2, wherein the plurality of display modes and the new display mode are further specified by a refresh rate, a color depth, a rotation angle, a position, or enabling or disabling of three dimensional display of a display device connected to each of the one or more video signal output ports.

8. The electronic apparatus of claim 1, wherein the screen display module is configured to display information when a third item of the plurality of items indicative of the plurality of display modes or the item indicative of the new display mode has been focused, the displayed information indicative of a display mode corresponding to the focused third item.

9. A display control method of controlling an electronic apparatus comprising a storage device configured to store a plurality of pieces of display mode setting information indicative of a plurality of display modes, the method comprising:
displaying a screen comprising a plurality of items indicative of the plurality of display modes and a first item for adding a new display mode;
switching the display mode based on first display mode setting information among the plurality of pieces of display mode setting information when a second item of the plurality of items has been selected, the first display mode setting information corresponding to the second item; and
adding display mode setting information to the storage device when the first item has been selected, the added display mode setting information indicating a new display mode which is currently used,
wherein the displaying comprises displaying the screen which further comprises an item indicative of the new display mode.

10. A non-transitory computer readable medium having stored thereon a program for a computer comprising a storage device configured to store a plurality of pieces of display mode setting information indicative of a plurality of display modes, the program being configured to cause the computer to:
display a screen comprising a plurality of items indicative of the plurality of display modes and a first item for adding a new display mode;
switch the display mode based on first display mode setting information among the plurality of pieces of display mode setting information when a second item of the plurality of items has been selected, the first display mode setting information corresponding to the second item; and
add display mode setting information to the storage device when the first item has been selected, the added display mode setting information indicating a new display mode which is currently used,
wherein the displaying comprises displaying the screen which further comprises an item indicative of the new display mode.
